(19) United States
(12) Patent Application Publication
(10) Pub. No.: US 2019/0228469 A1
(43) Pub. Date: Jul. 25, 2019

(54) METHOD AND APPARATUS FOR A CONSUMER CONTROLLED, DECENTRALIZED FINANCIAL PROFILE

(71) Applicant: Blend Labs, Inc., San Francisco, CA (US)

(72) Inventors: Michael Yu, San Francisco, CA (US); Eugene Marinelli, San Francisco, CA (US); Nima Ghamsari, San Francisco, CA (US)

(73) Assignee: Blend Labs, Inc., San Francisco, CA (US)

(21) Appl. No.: 16/254,484

(22) Filed: Jan. 22, 2019

Related U.S. Application Data
(60) Provisional application No. 62/641,553, filed on Mar. 12, 2018.
(60) Provisional application No. 62/620,453, filed on Jan. 22, 2018.

(51) Int. Cl. G06Q 40/02; G06Q 20/06; G06Q 20/36; H04L 9/06

(52) U.S. Cl. CPC G06Q 40/02; G06Q 20/0658; H04L 2209/38; H04L 9/0618; G06Q 20/363

(57) ABSTRACT

The system provides a method of storing the financial data of a consumer in a lockbox on a blockchain. The financial data is written to a lockbox by a writer (e.g. credit bureau, financial institution, data provider). The data is read by a reader (e.g. lender, investor, and the like). The blockchain technology provides security and auditing so that the information can be trusted, and any modifications can be identified and confirmed. The lockbox comprises a smart contract and SMPC group participants.

This patent application claims priority to U.S. Provisional Patent Application Ser. No. 62/620,453 filed on Jan. 22, 2018 and U.S. Provisional Patent Application Ser. No. 62/641,553 filed on Mar. 12, 2018, both of which are incorporated by reference herein in their entirety.

### BACKGROUND OF THE SYSTEM

An important asset of consumers is their credit history. There are many companies that have access to, and keep records of, the credit and financial transactions of a consumer. Some of these include banks, credit card companies, and credit reporting bureaus. Often a consumer is assigned a so-called “credit score” by agencies such as Equifax, Experian, and TransUnion. This data, and the credit score, has an outsized impact on the ability of a consumer to conduct financial transactions, including getting loans, credit cards, lines of credit, mortgages, and the like. A credit score can even impact the opportunity for employment.

Many of the limitations of the current system are imposed by its centralized nature. Since the data is controlled by massive third parties, it is impossible for the system in place to inherently support consumer consent and access transparency. The party with the database is always able to read the data, edit audit logs, and resell the data without consumer knowledge. The current system leads to disadvantages, including 1) trust and verification of data, 2) consumer access, and 3) consumer consent and access transparency.

There is a trust and verification problem because financial institutions cannot simply trust data provided to them by a consumer. The institution must independently verify the consumer data, adding cost and complexity to the process of making a risk decision. This effort is typically done manually, with staff reading documentation and reconciling the information provided by the consumer. As a result, institutions incur significant costs procuring documentation in an attempt to verify consumer data when making a risk decision. The documentation can be in the hundreds of pages, including bank statements, tax returns, proof of income, and the like, just to verify the consumer's stated assets and income. This adds cost, delay, and friction to the risk decision process.

The consumer access problem arises because consumers must access different systems (with the help of some third party, such as a credit reporting agency) to determine if the consumer's own data is accurate as to income, credit, payment history, and the like.

Consumer data is often shared between parties without the consumer having knowledge of how it is shared, leading to consumer consent and transparency issues. This information is also in the hands of third parties and the consumer must engage and trust these third parties as to the accuracy of the transaction histories.

The risks and disadvantages of the current system for consumers has been recognized for a long time. Efforts to provide access and protection for the consumer include the Consumer Financial Protection Bureau releasing a set of ‘Consumer Protection Principles” to guide how the financial services industry thinks about data. These include consumer access, consumer consent (and accompanying ability to revoke), security, and access transparency.

The industry is currently very limited in its ability to promote these principles. Most consumer financial data are controlled by third parties, as noted above. This creates a model that inherently demands consumers place trust in these institutions, and these third parties become necessary to provide consumer access, respect consumer consent, and provide security and access transparency. Enforcing these principles across the many market players also requires regulatory oversight, which must be done out-of-band and at significant additional cost.

Another problem with the current system is the necessity of needing to access and provide a large amount of documentation and data when applying for a loan, for example. Often a consumer will need to duplicate the same documents and data to multiple lenders, or to duplicate the same data over relatively short time periods, with the need to update some, or all, the documents and data accordingly. This is an administrative burden on the consumer. In addition, the lender may share the data with secondary market investors and data verifiers, without the consumer clearly understanding these data disclosures.

There are high costs to using verified data early in a loan origination process. Instead a lender will often collect and validate with documents in the beginning, and use verified data only after they believe the customer needs and/or qualifies for a particular financial product (e.g. a loan). This creates unnecessary work due to the high cost of verified data.

An additional problem with centralized control of financial data is the security risk to millions of consumers due to data breaches. These centralized stores are targets for malicious parties. Additionally, the centralized storage entity charges high fees for access to this high value data, charges that are ultimately passed on to the consumer.

A system that provides solutions to at least these problems is needed.

### SUMMARY

The system utilizes a public, anonymized ledger to allow a consumer to see plainly the source of truth access log for their own financial data, as well as directly control access to that data. The system provides a single hub for the consumer to control the consumer's entire financial profile. The consumer can use the hub to easily and securely share data with trusted financial institutions. The consumer benefits from full transparency of the data stored on their profile and its usage. The system provides a method of storing the financial data of the consumer in a lockbox on a blockchain. The financial data is written to a lockbox by a Writer (e.g. credit bureau, financial institution, data provider). The data is read by a Reader (e.g. lender, investor, and the like). The blockchain technology provides security and auditing so that the information can be trusted, and any modifications can be identified and confirmed. The lockbox comprises a smart contract and secure multiparty computation (SMPC) group participants.

### BRIEF DESCRIPTION OF THE DRAWINGS

FIG. 1 is a block diagram of an embodiment of the system.

FIG. 2 is a block diagram illustrating an embodiment of Lockbox 101.

FIG. 3 is a flow diagram illustrating the operation of SMPC in an embodiment of the system.

FIG. 4 is a flow diagram illustrating the operation of the AssignGroup protocol in one embodiment of the system.

FIG. 5 is a flow diagram illustrating the operation of ChallengeResult in an embodiment of the system.

FIG. 6 is a flow diagram illustrating the identity operation in an embodiment of the system.

FIG. 7 is a flow diagram illustrating the key recovery operation in an embodiment of the system.

FIG. 8 is a block diagram of an embodiment of the system.

### DETAILED DESCRIPTION OF THE SYSTEM

The system uses blockchain technology to provide a decentralized, trusted repository of consumer financial information that can be trusted, verified, and easily used by consumers and financial institutions. The system enables consumers, data providers, and financial institutions to interact via a common protocol and shared distributed ledger to share consumer financial data. The blockchain implemented ledger is implemented in a practical application that manages access and payment so that the consumer has control of each party's permissions, the audit trail is immutable and public, and payment for data is built into the protocol to incentivize data providers to offer the highest quality data.

Although the system is described in relation to the protection of financial data, it should be understood that the system may apply to any type of data that could be written by a trusted party, associated with a user, and desired to be read by readers, including personal records, personal information, health records, medical records, financial records, financial activity, financial analytics, media content, intellectual property, identity, employment history, criminal record, background, and the like.

The system utilizes private storage on a blockchain based on SMPC. SMPC is described, for example, in Luongo and Pon. The Keep Network: A Privacy Layer for Public Blockchains. https://keep.network/whitepaper, Zyskind, Nathan, and Pentland. Decentralizing Privacy: Using Blockchain to Protect Personal Data. https://www.enigma.co/ZNP15.pdf, and Vitalik Buterin. Privacy on the Blockchain. https://blog.ethereum.org/2016/01/15/privacy-on-the-blockchain/, 2016. Accessed: 2018 Jan. 15.

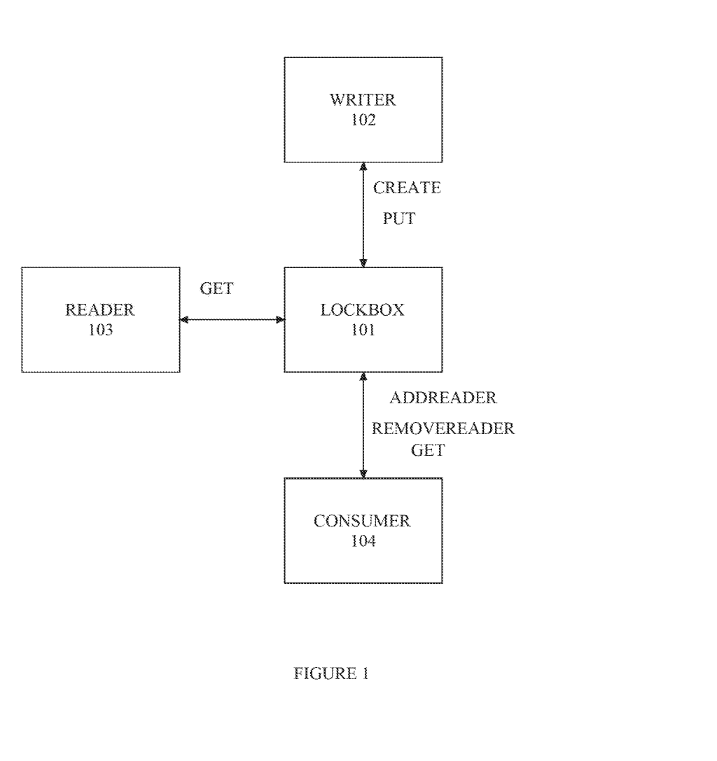

The present system uses SMPC to provide a construct referred to herein as a “lockbox”. The system is described at a functional level in one embodiment in FIG. 1. The system includes the Lockbox 101 which can be communicated with by a Writer 102, Reader 103, and Consumer 104.

Lockbox 101

The Lockbox 101 is a smart contract that stores data provided by Writer 102 about Consumer 104. Lockbox 101 can execute CREATE and PUT functions from Writer 102, GET function from Reader 103, and ADDREADER, REMOVEREADER, and GET functions from Consumer 104. The functions allow a Writer 102 to contain and share a secret with Consumers 104 and Readers 103 who are authorized (in one embodiment, authorization means the Consumer 104 and/or Reader 103 have paid). To access the data protected by the Lockbox 101, a Reader 103 must provide the smart contract with payment. The Lockbox 101 will additionally validate that the Consumer 104 has given permission for this Reader 103 to access the data before providing the contents of the Lockbox 101, encrypted with the Reader's 103 public key.

The data is the Consumer's 104 data, stored off the blockchain in one embodiment, encrypted, in a storage solution that can be read by any party with the URL address and decryption key. The data D is encrypted with a symmetric key k_{D} and is stored at a URL U_{D}. (U_{D}, k_{D}) is stored in the lockbox, encrypted such that an SMPC group is needed to decrypt it in an embodiment of the system. In one embodiment, the URL can be stored in the log of the smart contract, to avoid paying for storage costs on the blockchain. In one embodiment, the log is subject to a Merkle proof or the like to validate that the log existed as expected.

The data in a Lockbox 101 can be updated by a Writer 102 as frequently as a Writer 102, Reader 103, and Consumer 104 might agree. For instance, bank account information might be updated daily, while credit information might only be updated monthly. Any update frequency can be used without departing from the spirit and scope of the system.

Consumer 104

The Consumer 104 is any party who is a designated owner of one or more lockboxes and where ownership means that the consumer has the ability to give others permission to view the contents of the Lockbox 101. For example, a Consumer 104 can own a Lockbox 101 that contains the credit history and financial information of the Consumer 104. The system groups lockboxes by Consumer 104 on a blockchain. Any party can add a Lockbox 101 to a Consumer's 104 profile, provided that the Lockbox 101 identifies the Consumer 104 as the owner of the Lockbox 101 (i.e. the public keys match). For any Lockbox 101 that a Consumer 104 owns, the Consumer 104 can manage the permissions of Readers 103 on that Lockbox 101 via ADDREADER and REMOVEREADER functions. The Consumer 104 also can view the data inside of a Lockbox 101 they own via the GET function. In one embodiment, a Consumer 104 will have one profile but could have many Lockboxes 101 associated with the profile.

Writer 102

The Writer 102 is a party such as a credit bureau, financial institution, or data provider. The Writer 102 is responsible for writing and attesting to data in the system (i.e. in the Lockbox 101). A Writer 102 creates (but does not own) lockboxes and puts data inside of them. A Writer 102 might write to hundreds or thousands (or more) of lockboxes over time and needs an effective way to manage them. For that reason, a Writer 102 needs a way to group lockboxes that might hold similar types of data and thus might charge similar prices to readers. In one embodiment, the Writer 102 does not need to have any state.

Reader 103

The Reader 103 is a party that reads data from consumer profiles. In one embodiment the Reader is a party who has paid to retrieve data from a Lockbox 101. The Reader 103 may be a lender, investor, or institution that makes risk decisions or otherwise needs to observe the data. A Reader 103 pays to retrieve data from the Lockbox 101. A Reader 103 doesn't need to have any state (other than the system token balance and a public key, which all parties have). A Reader 103 simply interacts with lockboxes when given permission to do so and is only able to read the data. It should be noted that there may be multiple Readers 103 using the system.

Each of the entities described in FIG. 1 has an address a_{E}, an RSA key pair (pk_{E}, sk_{E}) and a token balance T_{E} denominated in a stablecoin such as, for example Tether or any other suitable stablecoin. These tokens can be transferred between entities using an external transfer function provided by the stablecoin referred to herein as transferTo.

Lockbox Model

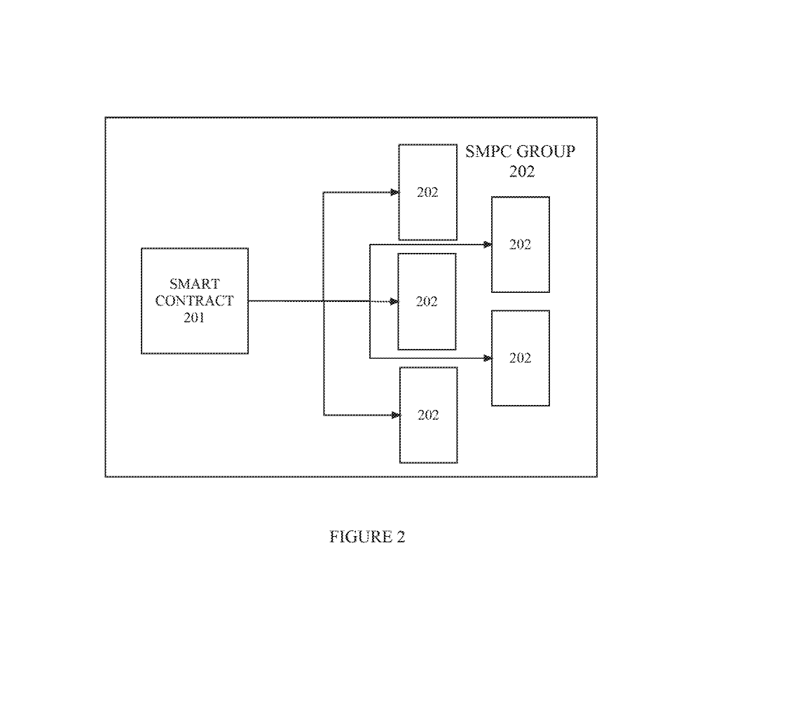

As shown in FIG. 2, a lockbox consists of two components in one embodiment, a Smart Contract 201 linked to an SMPC Group 202 of participants. The Smart contract 201 is a contract that maintains some publicly available state and validates that the necessary conditions have been met for the Lockbox 101 to return data to a Reader 103, encrypted with the Reader's 103 public key.

The SMPC Group (aka Management Group) participants 202 are a set of Lockbox 101 providers, each of which has a share of the Lockbox's 101 secret key sKₗ. Together, this group can run a secure multiparty computation to re-encrypt the Lockbox's 101 contents with pk_{R} to fulfil a request from a Reader 103.

Smart Contract

The lockbox smart contract maintains some public state and allows parties to execute a set of functions. The state maintained by the Smart Contract can be represented as:

```
type Lockbox {
  consumer: Address,
  writer: Address,
  permissionedReaders: Set[Address],
  paidReaders: Set[Address],
  smpcLeader: Address, // Leader of the SMPC group
  smpcGroup: Set[Address], // Set of SMPC members, of size n - includes smpcLeader
  smpcShares: String, // Content hash on storage network of encrypted shares of sk_L
  contentHash: String, // Content hash encrypted with pk_L
  contentKey: String, // Content key encrypted with pk_L
  price: Number, // Price reader must pay writer to access data, denominated in stablecoin
  transactionFee: Number, // Cost per SMPC member to retrieve content, denominated in stablecoin - the [symbol]
      total transactionFee * group size is a fixed percentage of the price
  smpcDeposit: Number, // Deposit an SMPC group member must store to participate, denominated in [symbol]
      stablecoin
  challengeDeposit: Number// Deposit for a reader to challenge the SPDZ result, denominated in [symbol]
      stablecoin
}
```

The functions it exposes are:

Create creates a Lockbox 101. The function sets the Consumer 104, Writer 102, and identifies the providers that will constitute the SMPC group.

Put allows the Lockbox's 101 Writer 102 to populate or modify the data it contains. The Lockbox 101 is empty when it is first constructed, so populating this state is key to executing other functions.

AddReader/RemoveReader allow a Consumer 104 to manage the set of permissioned readers.

Get allows a permissioned Reader 103 (or the Consumer 104 owner) of a Lockbox 101 to get the data it contains.

PostResult is called by the SMPC group leader to submit the result.

ChallengeResult is called by a Reader to challenge the result provided by the SMPC group leader, if the Reader believes that the SMPC group did not produce a valid result.

These functions are described in more detail below.

Secure Multiparty Computation

One question with the Lockbox 101 is: who holds the key to the Lockbox 101? Once the data is inside, who can send it and the Writer's 102 attestation to a Reader 103?

Giving the key to either the Consumer 104 or the Writer 102 creates availability requirements that shouldn't be imposed on either party. Using the system to share data needn't require parties to synchronously respond to requests to read the data, as Consumers 104 and Writers 102 might be smaller parties who are not interested in maintaining a continuous (24/7) node on the network. A Reader 103 should be able to read a Lockbox 101 asynchronously of the Consumer's 104 consent or the Writer's 102 posting of the data.

There are weaknesses in the incentives with giving the key to the Consumer 104 or Writer 102 as well. Giving the key to the Consumer 104 would mean the Writer 102 has no guarantee of getting paid when the data is read and used. As the Writer 102 is providing a useful service by being an unbiased source of truth, as well as attesting to the data and providing it to the consumer, this would break down the system's incentives.

There are also incentive-related flaws with having the Writer 102 as the decryptor of the Lockbox 101. The Writer 102 has the data, and may choose to withhold it from certain Readers (e.g. a competing financial institution if the data will be used so that the consumer can easily move their financial business to the competing institution). Giving the key to the Writer 102 gives too much control of the data from the consumer to the writer.

SMPC is one solution to this problem. SMPC is a cryptographic approach that allows a set of disinterested and independent parties, some of whom might be dishonest, to collectively perform a computation on a secret without revealing it. In SMPC, a secret is split across many parties, and each party independently applies some function to their share of the secret. The caller then combines these partial results to determine the full result without revealing it to any individual participant.

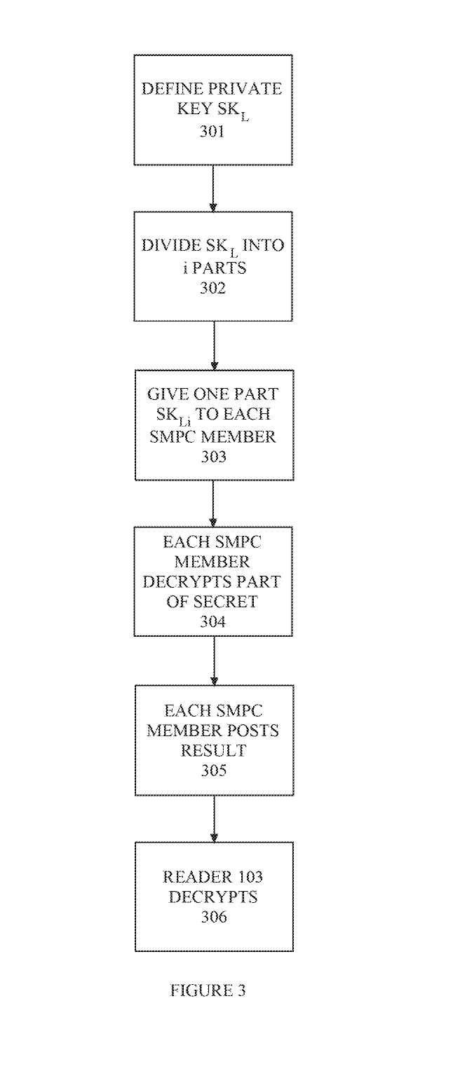

The operation of SMPC in one embodiment of the system is described in the flow diagram of FIG. 3. A Lockbox 101 applies this to distributed RSA decryption. At step 301 the system defines a private key skₗ. At step 302 the private key skₗ is divided into i parts, skₗᵢ. At step 303, each party to the SMPC in a Lockbox 101 is given a share of the Lockbox's 101 private key, skₗᵢ. This corresponds the CREATE function described below. When a Reader 103 wants to retrieve the data and from the Lockbox 101, each SMPC Group 202 member follows the SPDZ (a secret-sharing-based multi-party computation protocol) to encrypt the secret with a pkₛₑₛₛᵢₒₙ that is generated as part of an RSA key pair by the Reader. The SMPC leader then posts the final output RSA.Encₚₖₛₑₛₛᵢₒₙ ((H_{d}, k_{D})) to the blockchain. The Reader can then decrypt the secret and use it to retrieve the data. Note that in one embodiment, the SMPC leader performs the same duties as any other SMPC group member, with the additional duty of posting the final result to the blockchain for the group.

Lockbox Functions

CREATE

To post data about a Consumer 104, a Writer 103 must first create a Lockbox 101. The Writer 103 first determines the SMPC group {s₁, . . . sₙ}. The Writer 102 then generates a new RSA key pair (pk_{L}, sk_{L}) and splits sk_{L} into shard {sk_{Ll}, . . . sk_{Ln}} using a secret sharing algorithm such as Shamir's Secret Sharing described in (https://en.wikipedia.org/wiki/Shamir%27s_Secret_Sharing. Accessed: 2018 Jan. 25.) Each shard is associated with sᵢ and encrypted using pkₛᵢ, yielding the mapping:

$$smpcShares \text{:=} \{ {s}_{1} \text{:} RSA . {Enc}_{{pk}_{{s}_{i}}} ( {sk}_{{L}_{1}} ) , … , {s}_{n} \text{:} RSA . {Enc}_{{pk}_{{s}_{n}}} ( {sk}_{{L}_{n}} ) \}$$

It should be noted that the description herein refers to RSA and AES encryption schemes but the system is not limited to these schemes. Any suitable encryption scheme may be utilized.

In one embodiment, the system does not actually post smpcShares directly to the smart contract, as the contract does not necessarily need to interact with smpcShares (only the SMPC group members). The system can store it on the hash keyed storage network used for the data, and posts only a hash of the shares on the contract. The shares are still public. This embodiment is a scalability optimization. A Writer encrypts information D about Consumer 104 with a new symmetric key k; and stores AES.Enc_{kd}(D) on the storage network, keyed on hash H_{D}. The Writer then posts RSA.EnCₚₖₗ((H_{D}, K_{D})) to the blockchain as part of Create. In one embodiment, all information could be written to the chain.

The Writer 102 then calls Create on smpcShares.

Algorithm 1 CREATE

| | |
|---|---|
| 1: | procedure CREATE(C, price, smpcLeader, smpcGroup, smpcShares, contentKey, contentHash, |
| | transactionFee, smpcDeposit, challengeDeposit, W = caller) |
| 2: | assert(smpcLeader ϵ smpcGroup) |
| 3: | id := nextLockboxId( ) |
| 4: | LockboxRegistry[id] := { |
| | consumer : C, |
| | writer : W, |
| | smpcLeader : smpcLeader, |
| | smpcGroup : smpcGroup, |
| | smpcShares : smpcShares, |
| | contentKey : contentKey, |
| | contentHash : contentHash, |
| | price : price, |
| | transactionFee : transactionFee, |
| | smpcDeposit : smpcDeposit, |
| | challengeDeposit : challengeDeposit, |
| | version : 0 |
| | } |
| 5: | ProfileRegistry[C].lockboxes.add(id) |
| 6: | end procedure |

PUT

Put allows a Writer to update content of the Lockbox.

Algorithm 2 PUT

| | |
|---|---|
| 1: | procodure PUT(L, contentHash, contentKey, W = caller) |
| 2: | assert(W = L.writer) |
| 3: | L.contentHash := contentHash |
| 4: | L.contentKey := contentKey |
| 5: | L.version += 1 |
| 6: | end procedure |

ADDREADER/REMOVE READER

The Consumer 104 can manage the permissions of the Lockbox 101 by adding or removing permissioned Readers 103.

Algorithm 3 ADDREADER/REMOVEREADER

| | |
|---|---|
| 1: | procedure ADDREADER(L, R, C=caller) |
| 2: | assert(C = L.consumer) |
| 3: | L.permissionedReaders.add(R) |
| 4: | end procedure |
| 1: | procedure REMOVEREADER(L, R, C=caller) |
| 2: | assert(C = L.consumer) |
| 3: | L.permissionedReaders.remove(R) |
| 4: | end procedure |

GET

After permission is granted by Consumer 104, a Reader 103 can request the contents of the Lockbox 101 using GET. To do so, the Reader first generates an RSA key pair (pkₛₑₛₛᵢₒₙ, skₛₑₛₛᵢₒₙ) and passes pkₛₑₛₛᵢₒₙ into Get. Get also requires the Reader to pay the Lockbox price L.

Algorithm 4 GET

| | |
|---|---|
| 1: | procedure GET(L, pksession, R=caller) |
| 2: | assert(R ∈ L.permissionedReaders) |
| 3: | if R ∉ L.paidReaders ∪ {L.consumer, L.writer} then |
| 4: | transferTo(R, L, L.price) |
| 5: | L.paidReaders.add(R) |
| 6: | end if |
| 7: | transferTo(R, L, L.transactionFee * \|L.smpcGroup\|) |
| 8: | end procedure |

In one embodiment of the system, Consumer 104 is always a Reader 103 but does not have to pay the Writer 102 for the Consumer's 104 own data. However, the Consumer 104 may have to pay the transaction cost. In addition, the Writer can also run Get.

POSTRESULT

Once the Reader's 103 payment of the transaction fee to the Lockbox 101 has been recorded on the blockchain, each SMPC member sᵢ reads RSA.Encₚₖₛ (sk_{Li}) from L.smpcShares, decrypts it to get sk_{Li}. The SMPC group performs SPDZ off the blockchain to encrypt the shared secret into final result r=RSA.Encₚₖₛₑₛₛᵢₒₙ ((H_{D}, k_{D})), and then the SMPC leader publishes r to the blockchain using PostResult

Algorithm 5 POSTRESULT

| | |
|---|---|
| 1: | procedure POSTRESULT(L, R, r, version, s=caller) |
| 2: | assert(s = L.smpcLeader) |
| 3: | assert(no previous POSTRESULT involving L, R, and version)) |
| 4: | log(r, version) |
| 5: | for all sᵢ ∈ L.smpcGroup do |
| 6: | transferTo(L, sᵢ, L.transactionFee) |
| 7: | end for |
| 8: | if R ∉ {C, W} then |
| 9: | transferTo(L, L.writer, L.price) |
| 10: | end if |
| 11: | end procedure |

Once r is available the blockchain, the Reader 103 can decrypt it using RSA.Decₛₖ_{ₛₑₛₛᵢₒₙ} to recover ((H_{D}, k_{D})), fetch encrypted data from the network using H_{D}, and decrypt it using kD to get D.

ChallengeResult

In one embodiment, the system provides an enforcement mechanism that allows a Reader to claim that the secret received was malformed in some way or not delivered at all. The Reader in one embodiment puts up a deposit when challenging a result. The operation of ChallengeResult in one embodiment of the system is described in FIG. 5.

Algorithm 6 CHALLENGERESULT

| | |
|---|---|
| 1: | procedure CHALLENGERESULT(L, R=caller) |
| 2: | assert(R ∈ L.paidReaders) |
| 3: | transferTo(R, L, L.challengeDeposit) |
| 4: | end procedure |

At step 501 a result is posted by the SMPC group leader using PostResult after a Get operation. At step 502 a Reader who ran the Get operation receives the result and reviews the result. At step 503, if the Reader has doubt about the accuracy of the result, the Reader initiates ChallengeResult and posts a deposit for the challenge.

In response to the challenge, the SMPC group will execute the SPDZ protocol on the chain at step 504, where each step is publicly verifiable. If the SPDZ protocol is executed as specified, and if the result matches the original r from PostResult, the reader forfeits the challenge deposit, which is then shared among the SMPC group members. If the result does not match, or if a party deviates during the public execution of SPDZ, all SMPC group providers forfeit their deposits for the Lockbox that is subject to the challenge, and the challenge deposit is returned to the Reader who made the challenge.

The system checks at decision block 505 to determine if the result of the SPDZ operation in the challenge matches the original result r from PostResult. If so, the system proceeds to decision block 506 to determine if the SPDZ protocol was executed as specified. If so, the system proceeds to step 507 where the deposit of the challenging Reader is forfeited and shared to the SMPC group members.

If the result does not match at step 505, or if the SPDZ protocol was not followed at step 506, the system proceeds to step 508 and the deposits of the SMPC group for this Lockbox are forfeited and provided to the challenging Reader. In addition, the challenge deposit of the challenging Reader is returned to that Reader.

SMPC Group Management

SMPC Group membership should be carefully controlled, as the members are ultimately responsible for maintaining the integrity and security of the network.

Group Entry—In designing a mechanism for lockboxes to select SMPC group members, there are a few factors that should be considered:

The security of the data is parameterized by the number of members of the SMPC, as well as other parts of the selection process. These parameters should be selected by the Writer 102 as the Writer knows the value of the data and its sensitivity. It is possible that the parameters will vary by dataset (e.g. asset history is likely more valuable than employment history).

It should be difficult for an attacker to gain control of a specific Lockbox 101 intentionally—i.e. the group selection should not be deterministic or predictable.

Members of the SMPC group should be incentivized to behave in line with the protocol—i.e. return data correctly formed when called on and protect the secret in the lockbox otherwise.

For scalability purposes, it is desired to do as little selection as possible on the blockchain.

Accordingly, there are some requirements that a party should meet to be a member of an SMPC group:

SMPC groups are opt-in—a party must want to be in an SMPC group in order to be selected. In particular, they must opt in to participate at a given fee F and lockbox deposit LD, both a protocol-fixed percentage of the data price P. Each Lockbox deposit LD is in stablecoin in an embodiment of the system.

In addition, SMPC group members must hold a large amount of system tokens, staked in a staking contract from which the token can only be retrieved if the party is not a member to any lockbox's SMPC group. This is referred to as the SMPC member “stake”. This stake disincentivizes bad network behavior with the threat of a devaluation of the network currency should the network be compromised.

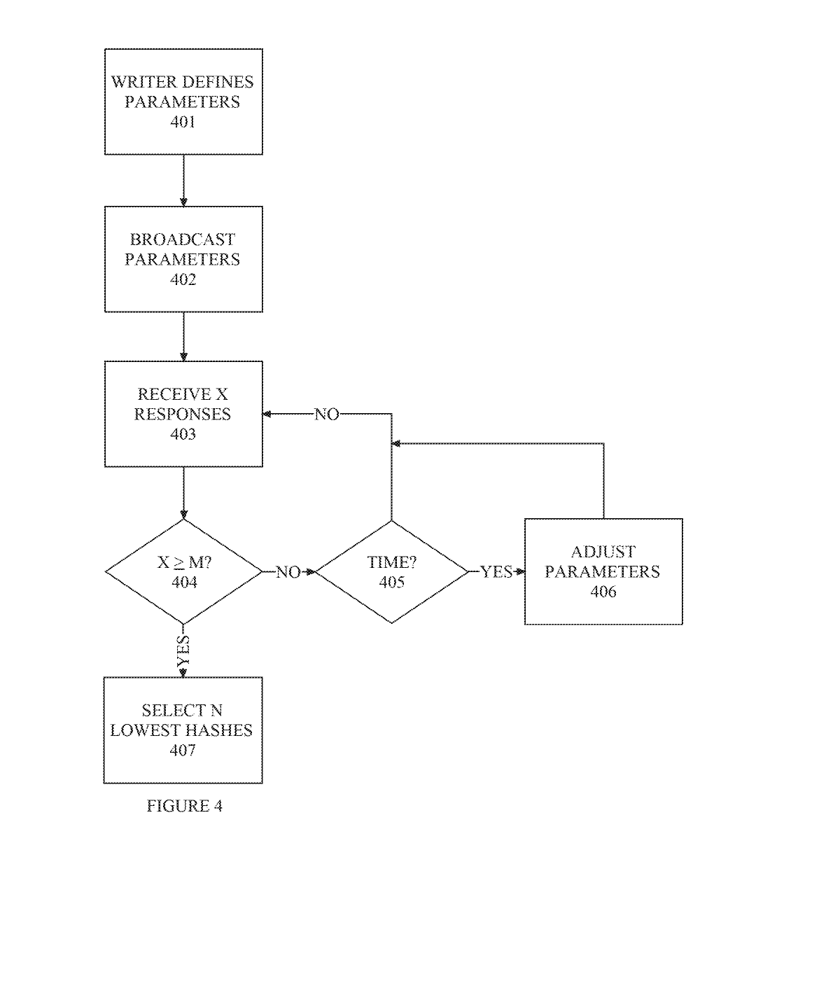

In order to meet all of these conditions, the system implements the AssignGroup protocol, which has three phases and is described in the flow diagram of FIG. 4:

Search for candidates. At step 401 the Writer 102 defines the parameters for the group. At step 402 the writer 102 broadcasts the parameters of the SMPC group, namely the price P (and thus implicitly the transaction fee F, and the amount that must be deposited to participate LD), the number of SMPC group members n, and the minimum number of candidates m≥n for the AssignGroup protocol to succeed.

Declare candidacy. Each party who wants to be considered for the SMPC group posts a signed response X to the search at step 403. (Each party to be considered must have an adequate stake in the network). This response consists of a public hash function H computed over the hash of the current block in the blockchain and the address of the poster (to generate some pseudo-randomness in the selection process), as well as the address of a standard staking contract in which the candidate has committed some reasonably large stake of system token.

Select group. At decision block 404 it is determined if the number of candidates X is greater than or equal to the minimum number of candidates m. If there are not at least m parties who declared candidacy, the system proceeds to decision block 405 to see if the time period for assembling the group has expired. If not, the system returns to step 403 to collect more responses. If the time period has expired, the protocol exits with no selection and the Writer 102 will need to try again, probably with a higher fee or otherwise adjusting the parameters at step 406. Otherwise, the n lowest hashes of eligible parties (those with large enough holdings) are selected to be the SMPC group at step 407. In one embodiment, the member with the lowest hash is selected as the SMPC group leader.

In one embodiment, the system implements Intel SGX (Software Guard Extensions) trusted hardware instead of, or in addition to, the SMPC group embodiment. SGX is a set of CPU instruction codes that allow a user to allocate enclaves (private regions of memory) that are protected from processes running at higher privilege levels. This can permit secure remote computation, web browsing, and digital rights management. SGX can be combined with a key management service (e.g. Fortanix) to provide a secure service that could be used to implement the system.

In one embodiment, the data may reside on a consumer device, providing true decentralized storage of data.

SMPC Group Exit

SMPC Group members should be able to exit the group associated with any Lockbox 101 at will and recover their deposit LD from that Lockbox 101. A Group member can exit all groups in which they participate, to thereby reclaim their stakes from the staking contract.

In order to do this, an SMPC group member sᵢ must broadcast intent to leave the group, as well as replace itself. To do this, it simply broadcasts F and LD, much as was originally done in AssignGroup, and the same Declare candidacy and Select group steps are executed to select a replacement member s_{new}. sᵢ then posts [symbol] (sk_{Li}), where sk_{Li} is the piece of the secret key which belongs to the leaving group member. The new group member makes a deposit of stablecoin (using SPDZ to verify that the share of the key delivered is correct), and the old group member's deposit is returned.

Incentives

While the above components make the system goals possible, incentives are also used. When designing a decentralized protocol, especially one meant to handle consumer information and power the financial system, it's important to incentivize good behaviour, such as the writing of truthful and high-quality data and the protection each secret contained in a lockbox.

In order to drive these incentives, the system uses two forms of cryptocurrency in one embodiment. One is used in the data sharing protocol for the Reader 103 to pay the Writer 102 to retrieve data from the Lockbox 101 and to incentivize the SMPC operation by paying fees to the SMPC group. This will be a stablecoin not native to the system in one embodiment.

The system implements a native system token which must be held by SMPC group members in order to participate. Because SMPC group members need to have significant holdings of system token, so they are incentivized to maintain the integrity of the network, lest their holdings be significantly devalued.

All data, keys, and tokens (of either type) change hands in the system protocol via transactions, which are recorded on the blockchain This also creates the immutable audit log, allowing Consumers 104 to identify who has read what data and how often.

The system is designed to bring simplicity and transparency to the Consumer 104. As a result, Consumer 104 incentives are aligned with system incentives. Consumer's 104 only need to authorize a Reader 103 to access their Lockbox 101 when there is a meaningful reason to do so, such as in a loan transaction, credit application, and the like. The Consumer 104 can remove all Readers 103 if desired, providing maximum security and privacy in between Consumer 104 authorized access to the Consumer 104 financial data.

A Writer 102 using the system is effectively selling the data that they may have on the Consumer 104. The data has value in that it comes from an unbiased and trustworthy source, and it can be made to be structured and high fidelity. The system incentives Writers 102 to do both.

The system's per-Reader payment model incentives Writers to provide data that is as valuable as possible. Although a future, on-chain representation of a Writer's reputation would further incentivize such behaviour, even today, buyers of financial data are taking these factors into account. Financial institutions such as Fannie Mae are establishing programs such as Day1 Certainty to warrant the trustworthiness of data providers (Writers). Writers who are able to build strong reputations as high quality data providers will see the usage of their Lockboxes increase, with associated profitability.

The Reader 103 is incentivized to pay for the data because paying for the data in the Lockbox 101 (as opposed to just having the Consumer retrieve the data and forward it) results in trusted and verified data.

The requirement of depositing system tokens by SMPC Group members helps incentivize those members to correctly post accurate results so as not to lose their deposits. The members are also incentivized via transaction fees for good behaviour. The members are incentivized to correctly post results via PostResult when a Reader has successfully executed Get, to post accurate results that can be used to derive the correct secret, and to not post results via PostResult at any other time, or to give the secret to unauthorized parties using any other method.

In one embodiment, the system uses tokens in several ways to maintain the incentives. In one, transaction fees in stablecoin are received for good behaviour (e.g. proper SMPC behaviour). In another embodiment members of the SMPC group must deposit stablecoin with a Lockbox to be part of the group. This deposit can be lost for failing to post accurate results (e.g. as a result of a ChallengeResult). It is desired for the members of the SMPC group to have a large stake (e.g. 0.01 to 1% of the network) of system tokens, disincentivizing behaviour that might devalue the system. In one embodiment, the system token is used only to serve as a license to participate in the SMPC group and collect fees.

To incentivize the posting of results, the Reader is paid a transaction fee when all members of the group have completed the valid PostResult. This fee is specified by the Writer when creating the Lockbox (also when the SMPC group is selected).

To incentivize the posting of accurate results the ChallengeResult protocol allows a Reader to punish SMPC groups for not doing so. In one embodiment, disputes can be settled by having the network validate the result posted by an SMPC group using a SPDZ proof. Each member of the SMPC group must post a proof that can be used to validate the correctness of the result the member is posting for the Reader. If the proof is unable to validate the correctness of the result, the challenging Reader may demonstrate it and collect the member's deposit LD.

The current distributed RSA implementation protects the secret even in the presence of n-1 dishonest nodes. If only one group member is honest, the secret will be protected. It would take n dishonest nodes to reveal the secret. Also, by requiring the entire group to have a large stake of tokens, the members are incentivized to protect the system integrity and thereby safeguard the value of the system tokens. Even for a unified dishonest group, the financial gain from compromising a Lockbox 101 would need to exceed the potential loss in the system token stakes.

Identity

The system provides a common standard for authentication of all data providers on the network, as well as a common standard for use of the consumer profiles. In current practice, data providers must authenticate a requestors' identity (e.g. Consumer) before it can share the data with a requestor. This may be through basic authentication, SSN-keyed authentication, and the like. Unfortunately, this often leads to consumers having to authenticate into many different systems to build out their financial profile.

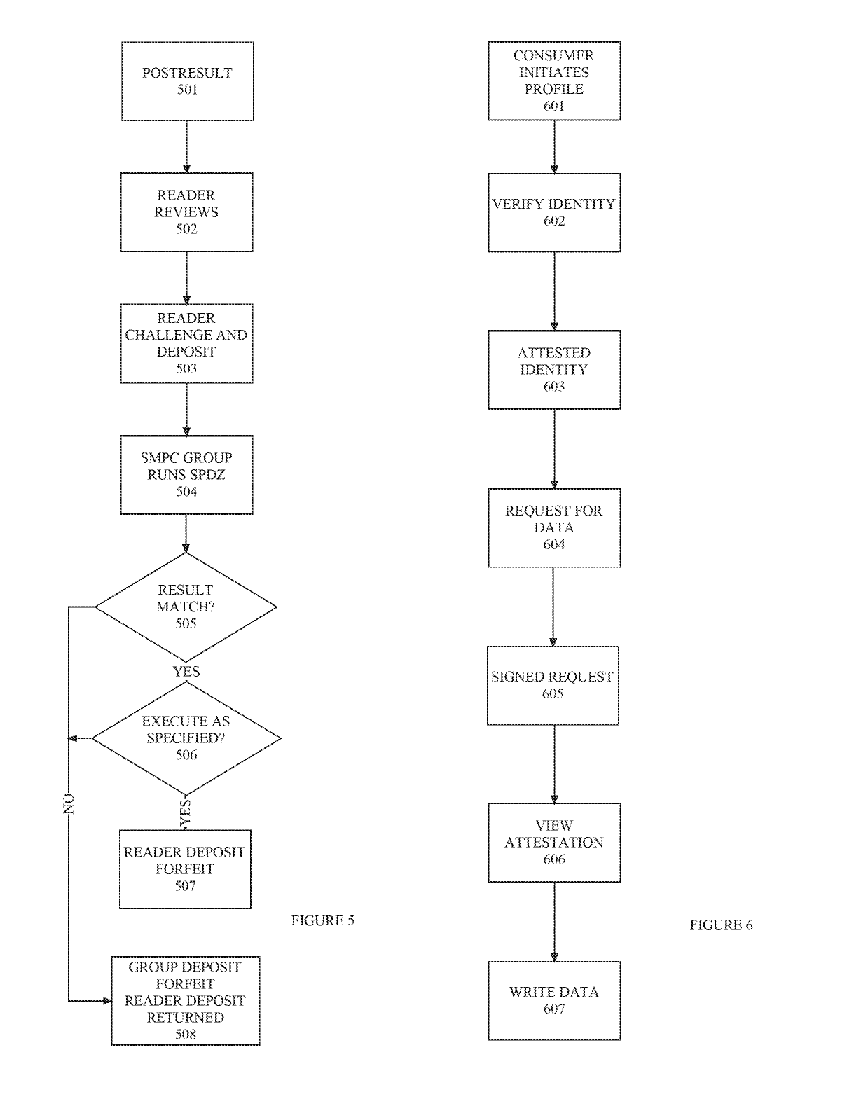

The system provides an authentication or Identity standard by which an actor on the network can prove to other actors on the network that they are who they purport to be. FIG. 6 is a flow diagram illustrating the operation of Identity verification in an embodiment of the system. At step 601 a Consumer initiates the creation of a key and a profile on the system. At step 602 the Consumer verifies their identity with a trusted identify provider, such as a credit bureau, government agency, and the like.

At step 603 the trusted entity writes a concept of the Consumer's identity in an attested manner to the system profile of the Consumer, where the attested identity is, for example, some combination of name, SSN, and/or some other identifying key (e.g. biometrics, fingerprints, and the like). At step 604 the Consumer asks a Writer (e.g. data provider) to write data about the Consumer to their profile.

At step 605 the Consumer sends a cryptographically signed request to the Writer, allowing the Writer to access the attestation of identity. At step 606 the Writer uses the request to view the attestation of identity provided by the trusted entity to confirm the key belongs to the requesting Consumer. At step 607 the Writer writes the requested data to the profile of the Consumer, having confidence in the identity of the Consumer.

In one embodiment, the identity key can be associated with other personal information of the Consumer (e.g. purchase history, browsing history, and the like) to enable targeted marketing, offers, opportunities, and the like to be presented to the Consumer when the Consumer offers their identity key to a Writer.

Lost Key

In many blockchain related systems, it is difficult if not impossible to disable a lost key. If a user of a cryptocurrency system loses their key and notifies the cryptocurrency system, the cryptocurrency system will not disable the key because they have no trust that the person reporting the lost key is the actual owner of the lost key. This is a disadvantage of current systems.

The present system provides a method for disabling lost keys. The method takes advantage of the Identity feature in the system. When a Consumer has participated in the system, one or more trusted Writers will have interacted with the Consumer and confirmed the identity of the Consumer. This identity confirmation is accomplished with the key of the Consumer. Therefore, multiple trusted parties will have history that ties a particular Consumer to a particular key.

In one embodiment, the Consumer has one key to their profile, where the profile may contain multiple lockboxes. If the Consumer loses the key, the system provides a mechanism for recovery. As noted above, the recovery of a key is a trust problem. That is, if the owner A of the key has no trusted connections with any other users B on a network, then there are no parties that can honestly attest that owner A has lost their key and replace the lost key on the network (as in a typical cryptocurrency exchange).

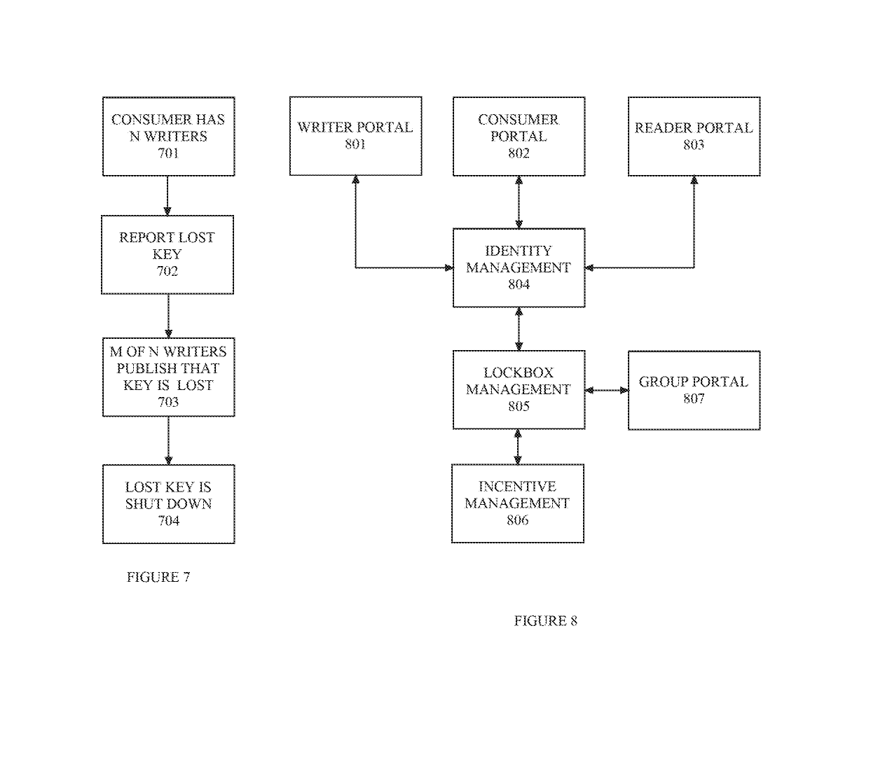

An advantage of the system is that trusted connections are inherently part of the system. A Consumer identifies itself to a Writer by providing the Identity attestation and Consumer key to the Writer. FIG. 7 is a flow diagram illustrating the operation of key management in an embodiment of the system. At step 701, for a Consumer C, there are, for example, n Writers on the profile of the Consumer (i.e. n Writers who have constructed Lockboxes for a given Consumer) where n is greater than or equal to some minimum number m of Writers. At step 702 the Consumer reports a lost key and informs the n Writers. At step 703, if at least m of the Writers publish a key that the Consumer reporting the lost key had actually previously had the lost key, at step 704 the system shuts down the Consumers lost key (i.e. the SMPC groups will no longer serve data from that profile about Consumer C. If at least m Writers do not publish confirmation that the Consumer had previously owned the lost key, the key will not be disabled. The minimum number m may be any value from 1 to n as desired. In one embodiment, the minimum value m may could be a function of n such as a ratio, and vary in n (e.g. m might be required to be at least 33% of the number of Writers).

FIG. 8 is a block diagram of a practical application of the system that improves the technology currently used for maintaining financial information and improves the technological field of financial data management and access. The system includes a Writer Portal 801, Consumer Portal 802, and Reader Portal 803 for access by Writers, Consumers, and Readers respectively. These portals access the Identity Management block 804. Identity Management 804 confirms the identity of actors attempting to engage the system from the various portals. Identity Management 804 also performs the steps of verifying identity for first time users and helps obtain the attested identity key described in connection with FIG. 6.

Lockbox Management 805 is used to manage Lockboxes and all aspects of their use and operation. Lockbox Management 805 implements commands from the Writers, Consumers, Readers, and SMPC Group members, including Create, Get, and the other commands noted above. Group Portal 807 allows access and communication with the SMPC Group members. Incentive Management 806 is used to track payments, stakes, deposits, challenge deposits, and other financial operations related to the system. When an SMPC group is proposed, the stakes of the proposed members are reviewed. Any member who does not have sufficient stake of system tokens may not be a member of the proposed SMPC group. In addition, any deficient member is removed from any other SMPC groups of which they may be a member. In one embodiment, this is accomplished by the group exit procedure noted above.

The system of FIG. 8 may include one or more computing devices that may be coupled to and connect over a wired or wireless communication path, including a network such as the Internet, or via a cloud computing implementation. Each computing device may be a processor based device with persistent storage, memory, a display and wired or wireless connectivity circuits that allow each computing device to exchange information with the elements described in FIG. 8. Each computing device may implement a browser application for exchanging data between the elements. The system may be implemented partially in hardware via standard CPUs, one or more special purpose processing units, or on specifically designed ASIC implementations. When implemented using a processing system executing machine readable instructions, the instructions may be stored in any non-transitory, tangible computer readable storage medium.

Thus, an improved financial data storage and access system has been described herein.

What is claimed is:

1. A method of providing a consumer-controlled, decentralized financial profile comprising:
using a Lockbox Management node to create a Lockbox for storing consumer financial data of a Consumer, wherein the Lockbox is defined by a Smart Contract;
using a Writer portal to allow a Writer to write consumer financial data to the Lockbox,
using a Reader portal to allow a Reader to read the consumer financial data from the Lockbox.

2. The method of claim 1 wherein the Consumer gives permission to the Reader to read the consumer financial data from the Lockbox.

3. The method of claim 2 further including a Group portal to allow a Lockbox Management group to manage access to the Lockbox.

4. The method of claim 3 further including an Identity node to confirm the identity of the Consumer.

5. The method of claim 4 further including an Incentive Management node to track financial transactions associated with the Lockbox.

6. The method of claim 5 wherein the Management group comprises a plurality of members and wherein each member has a financial stake.

7. The method of claim 6 wherein each member makes a deposit LD associated with the Lockbox.

8. The method of claim 7 wherein the Management group posts a Result in response to a request to read financial information from the Reader.

9. The method of claim 8 wherein the Reader may challenge the accuracy of the Result.

10. The method of claim 9 wherein the deposit LD is forfeited to the Reader when the Result is not accurate.
